(19) United States
(12) Patent Application Publication
(10) Pub. No.: US 2008/0104080 A1
(43) Pub. Date: May 1, 2008

(54) METHOD AND APPARATUS TO ACCESS HETEROGENEOUS CONFIGURATION MANAGEMENT DATABASE REPOSITORIES

(76) Inventors: Monte Kim Copeland, Austin, TX (US); David Bruce Kumhyr, Austin, TX (US)

Correspondence Address: IBM CORP (YA);C/O YEE & ASSOCIATES PC, P.O. BOX 802333, DALLAS, TX, 75380, US

(21) Appl. No.: 11/555,452

(22) Filed: Nov. 1, 2006

(51) Int. Cl. G06F 17/30

(52) U.S. Cl. 707/10

(57) ABSTRACT

A computer implemented method, apparatus, and computer usable program code for accessing information in repositories. A determination is made as to whether a connector from a plurality of connectors may be used to retrieve the information for the item from the repositories for the request, wherein the connectors are reusable for accessing the repositories in response to receiving different requests in response to receiving a request from a requester for information about an item. Information is retrieved using the connector to form results in response to a determination that the connector may be used to retrieve the information about the item. The results are returned to the requester.

### BACKGROUND OF THE INVENTION

1. Field of the Invention

The present invention relates generally to an improved data processing system and in particular to a method and apparatus for accessing stored data. Still more particularly, the present invention relates to a computer implemented method, apparatus, and computer usable program code for accessing data stored in different repositories.

2. Description of the Related Art

In a large organization, different parts of the organization may use different types of database systems to store and search for data. The use of different types of database systems may originate from different groups within the organization starting the different types of database systems. Additionally, changes in an organization, such as, for example, mergers, acquisitions, or joint ventures may result in heterogeneous database systems being present within the organization. It is often desirable for different portions of the organization to be able to access data from other portions of the organization. Problems come about in accessing the data because of the different types of database systems present within the organization. Further, in joint ventures, two different organizations may allow access to each others databases in which those databases may employ different systems for management and access.

One solution requires the different users to have access to and be proficient with the software for different database systems. For example, a user familiar with one database may use one term for a particular item. The same item in another database may be referred to using a different term. As a result, in order for the user to access information for the item in both databases, the user is required to be familiar with the terminology used in both databases. This problem is complicated when information is located across many databases for the item. Requiring users to learn different database systems and to have access to the software needed for those systems is time consuming and complex.

Another solution involves bringing together data from the different databases into a single central database having a single system for accessing the merged data. Using a central database oftentimes results in requiring complex consistency checks to ensure changes in the databases are propagated to the central database. This type of central database system also requires an increased expense and time in terms of the additional components needed to retrieve and store the data from the remote databases.

Therefore, it would be advantageous to have an improved method, apparatus, and computer usable program code for accessing data located in different sources.

### SUMMARY OF THE INVENTION

The present invention provides a computer implemented method, apparatus, and computer usable program code for accessing information in repositories. A determination is made as to whether a connector from a plurality of connectors may be used to retrieve the information for the item from the repositories for the request, wherein the connectors are reusable for accessing the repositories in response to receiving different requests in response to receiving a request from a requester for information about an item. Information is retrieved using the connector to form results in response to a determination that the connector may be used to retrieve the information about the item. The results are returned to the requester.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 is a block diagram of a data processing system in which illustrative embodiments may be implemented;

FIG. 3 is a diagram illustrating components used in providing access to different repositories in accordance with an illustrative embodiment;

FIG. 4 is a diagram illustrating an interface object in accordance with an illustrative embodiment;

FIG. 5 is a diagram illustrating a connector in accordance with an illustrative embodiment;

FIG. 6 is a diagram illustrating an example of connection data in accordance with an illustrative embodiment;

FIG. 7 is a diagram illustrating message flow in processing a request from a client in accordance with an illustrative embodiment;

FIG. 8 is a diagram illustrating message flow used in retrieving information from repositories in accordance with an illustrative embodiment;

FIG. 9 is a flowchart of a process for an interface object in accordance with an illustrative embodiment; and

FIG. 10 is a flowchart of a process for a connector object in accordance with an illustrative embodiment.

### DETAILED DESCRIPTION OF THE PREFERRED EMBODIMENT

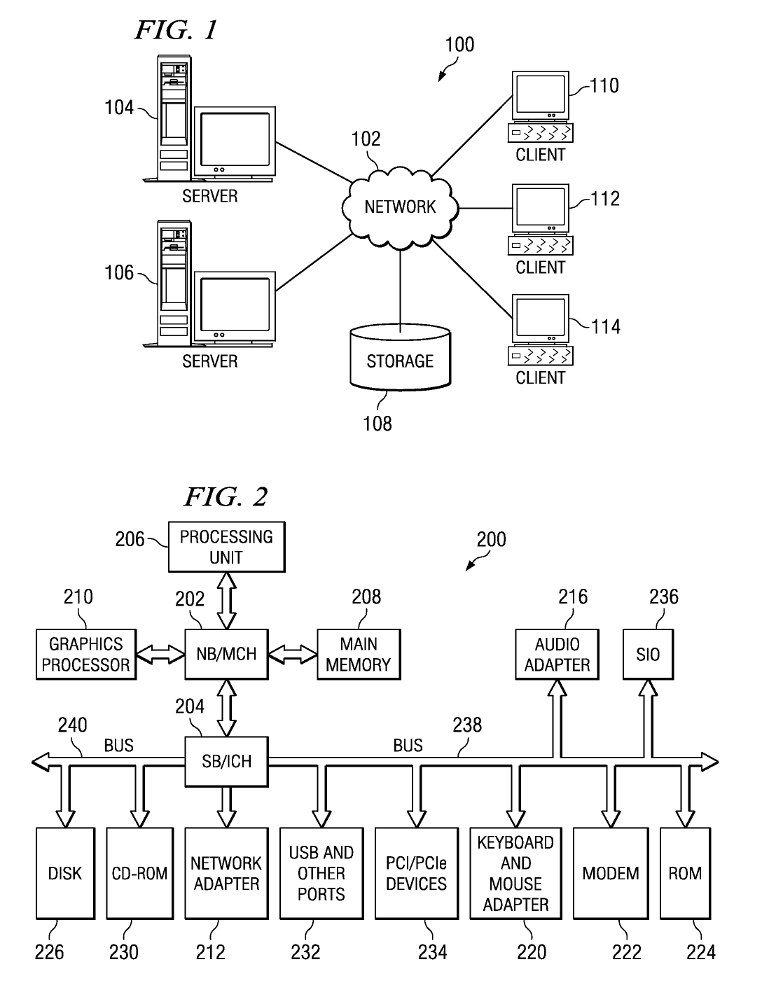

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which illustrative embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which illustrative embodiments may be implemented. Data processing system 200 is an example of a computer, such as server 104 or client 110 in FIG. 1, in which computer usable code or instructions implementing the processes may be located for the illustrative embodiments.

In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processor 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processor 206. The processes of the illustrative embodiments may be performed by processor 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The illustrative embodiments provide a computer implemented method, apparatus, and computer usable program code for accessing information in repositories. When a request is received from a requester about an item, a determination is made as to whether a connector from a plurality of connectors may be used to retrieve the information for the item from the repositories to satisfy the request. A connector is an object that is used to connect to one or more repositories, such as databases, for purposes of conducting queries to obtain results. A connector includes the data and processes needed to query a repository. The processes may include processes to identify how a database is to be queried. A connector may be used by one database system that receives a query to send the query to other database systems to obtain results from the other databases. The connector may be used by a software component designed to query data sources to connect to data sources. This software component may not include data.

These connectors are reusable for accessing the repositories in response to receiving different requests. If a connector may be used to retrieve information about the item, the information is retrieved using a connector to form results which are returned to the requester. If the connector cannot be used to retrieve information for the item, a new connector may be created to access the information. This new connector may be created using an existing connector as a template. The information for the item may then be retrieved using the new connector and the new connector may be reusable to access information about the item in response to subsequent requests. Further, in the different illustrative embodiments, this accessing of information may be used to synchronize information about items across different repositories. Repositories in these illustrative embodiments are any collection of data stored in a data structure that may be accessed using an interface that responds to requests for queries. These different types of data structures may include, for example, databases, flat lists, serializable objects, serialized objects, or real time aggregations of system or application information. In creating a new connector, the different embodiments may use introspection to obtain the information needed to create the new connector. This introspection is performed on the repositories in which the information may be located. The data returned from the introspection process is used to create the new connector.

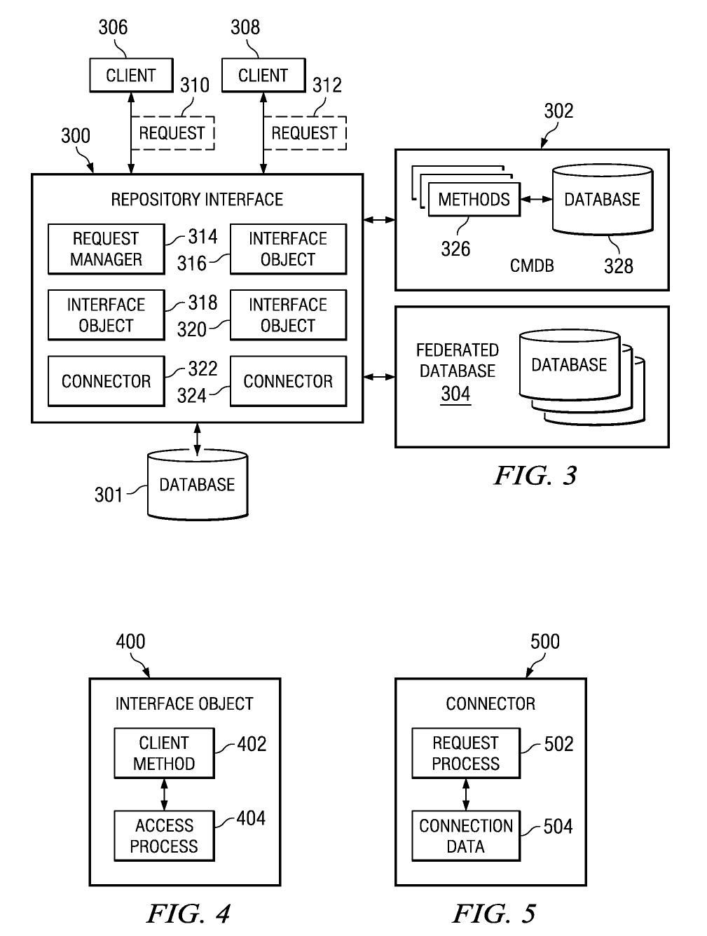

Turning now to FIG. 3, a diagram illustrating components used in providing access to different repositories is depicted in accordance with an illustrative embodiment. In these illustrative examples, a repository is any collection of data that may be accessed though a program. For example, a database or a configuration management database is an example of a repository. In this illustrative example, repository interface 300 provides an interface to access different repositories such as, database 301, configuration management database (CMDB) 302, or federated database 304.

In these examples, database 301 is a local database with respect to repository interface 300, while configuration management database 302 and federated database 304 are located in other geographic locations or other domains. A federated database is essentially a virtual database that is part of a database system. This system is used to transparently integrate multiple databases into a single federated database. The different databases may be connected through a network and may be located in different geographic locations. Configuration management database 302 is a unified or federated repository of information in these embodiments.

Configuration management database 302 serves as a single repository for configuration item information and attributes. For example, this type of database may hold details of elements within an information technology infrastructure. This database is typically used to manage and provide information technology services. In other words, configuration management database 302 is a repository that holds the relationships between infrastructure components and an information technology infrastructure. In these examples, the different elements may be, for example, a server, a tape library, a router, a workstation, a laptop, a printer, or a scanner. An item in an information technology system may be any resource that is used in the network. This type of database also could be federated, thus enabling existing databases to be connected to this type of system.

In these examples, the different repositories may refer to the same item using different terms. In these examples, these items are configuration items. A “configuration item” is an abstraction of an information technology resource, and is often a standard term in the information technology infrastructure library (ITIL®). Often, the configuration item refers to a standard piece of hardware, such as a monitor. However, configuration items may also be abstractions which refer to defects, people, and software of an overall system. For example, the term, “incident” is a user item term for some organizations used to describe a report made about a system defect or anomaly.

A “user item term” is a name of a configuration item, or an attribute thereof, which is entered in a field or other data structure in a local, possibly highly customized, configuration management database.

A “configuration item term” is a name of a configuration item, or an attribute thereof, which is entered in a field or other data structure in a master, preferably “standardized” configuration management database. In an illustrative embodiment, where possible standard information technology infrastructure library terms are used. However, this usage may not always be possible, and thus, the configuration item term may be “standard” only for a respective organization.

An “addressing name” is a term which allows a user to locate data concerning a configuration item. It may be a configuration item term, a user item term or some other term, pointer, path or class name which enables the system to find the configuration item data.

A respective, configuration item term may be the same as a respective user item term. However, for the invention to be useful, other terms will differ between the respective databases.

In some illustrative embodiments, to build or edit the interface objects in the repository interface 300, the user need not be familiar with a proprietary syntax and nomenclature used on disparate resource databases or repositories. An illustrative embodiment may permit queries using user field inputs wherein a pull-down menu or similar graphical user interface widget is used to locate a user item term or other equivalent associated configuration item term for a given user field input. A user field input can comprise character input to one or more fields. In addition, a user field input may include mouse inputs that select from a list, choose radio buttons, and click on a label to suggest that a user has completed selecting and refining his user field input. The user field input may be mediated by a hypertext protocol document shown on a browser that includes form controls. Often, though not always, a user field input may be completed by simply pressing an enter key on a keyboard.

A configuration management database stores data concerning the elements of a data processing system. A configuration management database may be stored on an array of hard drives coupled to one or more processors. The configuration management database usually has a software front-end to mediate accesses and perform housekeeping functions. A configuration management database can be an aggregated database where multiple databases or files are located for distribution over a network. A configuration management database can be local or remote to the user as would be readily appreciated by one skilled in network technology. A configuration management database may include redundant backup storage located distant from a primary facility.

The data that comprises the configuration management database includes configuration items, stored as collections of user item terms or configuration item terms. A configuration item represents a resource in an information technology environment, and includes both networked and stand-alone items. Such resources include both software, hardware, and personnel resources. Consequently, the relationships among configuration items and attributes of configuration items, and the terms which are used to define them, are many and complex.

As can be gathered from the description above, the plethora of terms can make accessing information, particularly in remote databases, confusing and difficult to the user. To this end, by means of the interface objects, the illustrative embodiments of the invention permit a user to access a configuration item by selecting a user item term familiar to the user.

In these examples, users at clients 306 and 308 may send requests, such as requests 310 and 312 to repository interface 300 for processing. These requests may include item terms for an item, such as a configuration item.

Repository interface 300 contains a number of components used to process these requests. In these examples, these components include request manger 314, interface object 316, interface object 318, interface object 320, connector 322, and connector 324. Request manager 314 serves to receive requests from clients, such as clients 306 and 308. In response, request manager 314 identifies appropriate components within repository interface 300 to process the requests. In response to results received from processing the requests, request manager 314 returns these results to clients 306 and 308. Further, request manager 314 also may create new interface objects as needed.

For example, request 312 may be identified as being appropriate for processing by an interface object, such as interface object 318. With this type of identification, request manager 314 passes request 312 to interface object 318. In turn, interface object 318 may directly generate the appropriate requests to retrieve data from configuration management database 302 and/or federated database 304. Alternatively, depending on the type of request, interface object 318 may use a connector, such as connector 322, to retrieve data from different databases, such as database 302 and federated database 304.

In this particular example, interface object 318 identifies the appropriate connector needed to obtain the information. Interface object 318 may identify one connector or a multiple connectors to satisfy the request. The identification of the connectors in these illustrative embodiments is made using introspection. Introspection is used in Java™ environments to obtain information about objects. In these examples, interface object 318 may identify the appropriate connector through this type of mechanism.

In these illustrative examples, a connector is used when the request requires data from more than one database. In this particular example, interface object 318 sends the request to connector 322, which in turn, makes the appropriate requests to configuration management database 302 and federated database 304. Of course, if the data may be retrieved directly from one database, interface object 318 directly makes the request to that database. For example, if the information may be requested from configuration management database 302 without requiring data from federated database 304, interface object 318 generates the request. In particular, interface object 318 sends the request to the appropriate method in methods 326 to query database 328 within configuration management database 302.

In these illustrative examples, connectors 322 and 324 contain information needed to access data sources, such as configuration management database 302 and federated database 304. These connectors are reusable. For example, the connectors may be imported to another location and used to access these data sources. Further, these connectors could be sent to one of the target sources, such as configuration management database 302 and used to access federated database 304 and database 328, which is local to repository interface 300. In this manner, a connector generated in one location may be used in other locations to access data. Data may be accessed in database 328 because connector 322 and connector 324 contain the information needed to identify corresponding items in the different databases.

Turning now to FIG. 4, a diagram illustrating an interface object is depicted in accordance with an illustrative embodiment. In this example, interface object 400 is a more detailed example of an interface object, such as interface object 318 in FIG. 3. Interface object 400 contains client method 402 and access process 404. Client method 402 is used to receive requests that may be passed to interface object 400 by a request manager, such as request manger 314 in FIG. 3. Client method 402 identifies an appropriate access to be made though access process 404.

Access process 404 actually generates the necessary commands and requests to obtain the data in response to receiving a request from the request manager. The request may be a request for information about an item using a term, such as a user item term that may have different names in different sources.

Access process 404 may determine that processing the request may be accomplished by accessing a single database. In this case, access process 404 then generates the appropriate request for the database.

In a different example, a determination may be made that more than one database is to be accessed. In that case, access process 404 sends the request to a connector, such as connector 322 in FIG. 3. In this case, access process 404 determines how the request should be made to the different databases to return the results desired. When the results are returned, access process 404 received those results and returns them to client method 402.

In these examples, access process 404 also includes a mechanism that may be used to obtain information from a data source in which the information is used to access the data source. In an illustrative embodiment, introspection is used to identify similar objects representing configuration items. In these illustrative embodiments, an introspector class of object, or simply an “introspector”, is an object that reads by means of an introspection method, a Java™ bean file or a Java™ file for properties, methods, and events. In this illustrative embodiment, information needed to access other sources is introspected. For example, interface object 400 uses access process 404 to introspect an object in a related management application that represents the configuration item, thus retrieving data for accessing source database for properties, methods, and events. The group of properties, methods, and events can be used to search the repository for existing connectors for similar configuration items, thus speeding the process of building a new connector. Introspection involves the interface object automatically matching a pre-built connector with the present configuration and using predefined rules or policies to provide menus of selections to guide the process of making a new connector.

Alternatively, during introspection, the interface object presents those methods, properties, and events to the user so that the user may select and match user item terms used in association with a second or heterogeneous configuration management database.

When performing introspection, access process 404 may find a first object, which represents a configuration item in a first management application managing the resources in a first network domain that is similar to a second object for a second configuration item that a management application in a second domain or for a similar management application in the second domain manages. When this situation happens, if a connector built for one of the configuration items is present, access process 404 may use that connector as a template for the other domain.

Furthermore, the access process 404 may utilize a pattern in a hierarchy of objects that relates objects for accessing the management application for building sets of connectors to communicate between each configuration management database in the interface object repository. Access process 404 forms a newly added access method as an object in this hierarchy. Further, access process 404 also may identify an appropriate connector for use in accessing a repository through introspection. Alternatively, access process 404 may use configuration information that identifies what repositories are needed to satisfy a particular request.

For example, three different ways may be present to access data for a particular request. The configuration information may identify the particular mechanism to be used. The particular mechanism that may be defined in this configuration information includes direct access using a vendor provided configuration management database program to access methods to the associated database. Another mechanism that may be identified in configuration information may be application programming interfaces provided by a database vendor for third party use. The configuration information also may identify introspected access using a connector to hook to vendor objects for a database, such as a configuration management database. As yet another example, the configuration information may point to user constructed access code used by the connector for the configuration management database.

In these examples, interface object 400 performs introspection using access process 404 on objects at different databases to select an appropriate connector. If an appropriate connector cannot be found, then an indication or flag is generated such that a connector may be selected or created through user input. Additionally, if an appropriate connector cannot be found, access process 404 may include processes to select a connector with a closest match. In these examples, access process 404 identifies repositories, examines schemas, and maps the schemas in the initial configuration. Since the origin of the query is known, the first tier is if the identity of the configuration to be updated is unique, the repository can be mapped directly. Other repositories need to be updated by access process 404. This information is stored in an alternative address field in a connector data structure and these references are used to update the other repositories. If the references are not unique or are ambiguous, then the reference or pointer to the repository must be mapped or configured within the connector because this mapping cannot be identified by access process 404.

Turning now to FIG. 5, a diagram illustrating a connector is depicted in accordance with an illustrative embodiment. In this example, connector 500 is an example of a connector, such as connector 322 in FIG. 3. Connector 500 contains request process 500 contains request process 502 and connection data 504. Request process 502 identifies the different databases that need to be used to return the results for a request. Connection data 504 provides the data needed to generate the different requests.

For example, if the request being processed by request process 502 requires querying two different databases, connection data 504 is used to determine the location of those databases as well as how to generate requests to query those databases. With that data, request process 502 generates the requests and sends them to the two databases. Request process 502 also receives the results of any two queries made and sends them back to the interface object that sent the request.

In these illustrative examples, iString is a general Java™ class that may be used in which a base representation in the form of a general name may be used to refer to one or more alternative names that are used by different database systems referring to the same thing. With an iString, connector 500 is able to use this information to identify the same item in a different data source. As a result, with a general name for an item that is being requested, connector 500 may identify the name used for that item in different databases when having to retrieve data from multiple sources. In other words, an iString may be used as a translator for different names used to refer to the same item.

Connector 500 in these examples may be reusable in a different location. For example, a connector created at one repository for use in accessing that repository and two other repositories may be sent to another location for use to access all three repositories. Further, this connector may be sent to one of the other two repositories for use in accessing the other two. As a result, connector 500 may be reused by another user to access the same repositories. Further, this connector could be reused and modified to access repositories that have a similar pattern with respect to accessing data.

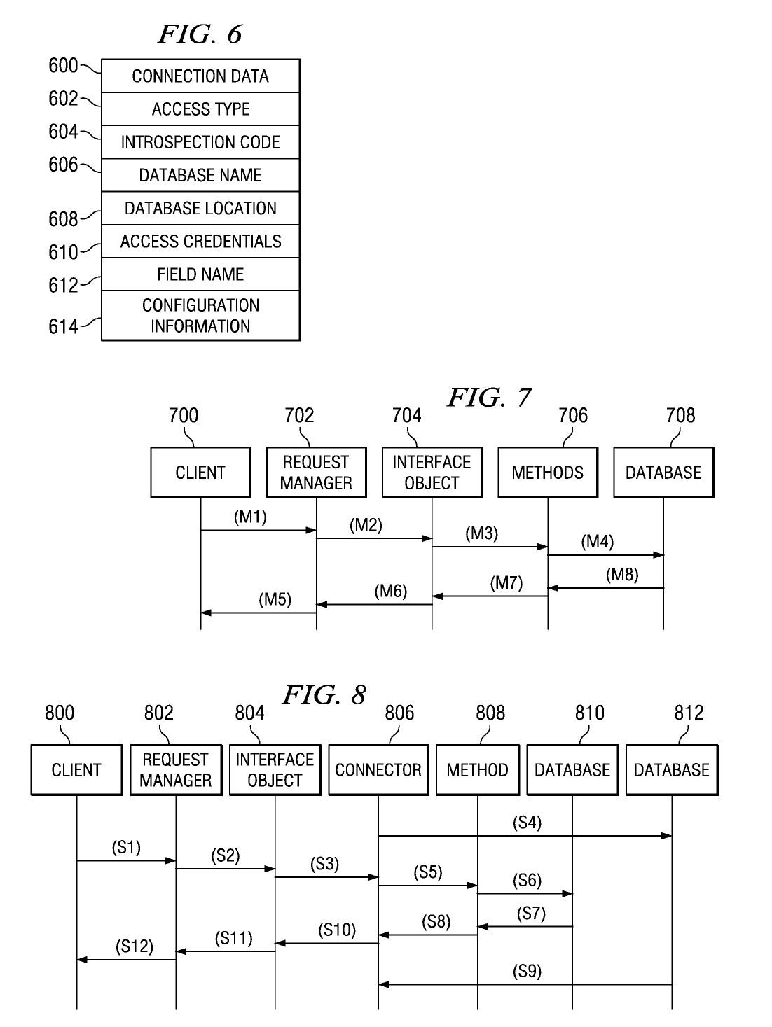

Turning now to FIG. 6, a diagram illustrating an example of connection data is depicted in accordance with an illustrative embodiment. In this example, connection data 600 is an example of connection data 504 used by connector 500 in FIG. 5. Connection data 600 contains any information needed for the connector to identify the location of information for a request being processed by the connector. In these illustrative examples, connection data 600 includes access type 602, introspection code 604, database name 606, database location 608, access credentials 610, field name 612, and configuration information 614. In these examples, access type 602 is used to determine how the particular database is to be accessed. Examples of access types include original/direct and a connector. Original/direct involves using the in-place system with its native data repository using its own interface. Access through a connector involves using a different user interface or front end system to view or alter data from a different system.

Introspection code 604 is instructions that are used by the connector to obtain information about an application. For example, introspection code 604 may be used to ask an object what class it is and introspectively make up the class. Further, introspection code 604 may be used to identify the name and data types of all of the properties and methods that make up a class. With this information, the connector may identify how a particular database is to be accessed.

Database name 606 identifies a particular database with the location being identified through database location 608. Database location 608 may be, for example, a URL, an IP address, or a path name. Access credentials 610 provide information needed to access the repository. Field name 612 contains information that is used to correlate multiple names to a single name. In these examples, field name 612 is stored as an iString.

Field name 612 provides the ability to access information for an item, such as a configuration item located in different repositories using a single term. Field name 612 allows for the single name entered to be used to identify other names that might be used to reference the same configuration item in different repositories.

Access type 602 may contain multiple mechanisms or ways to access a repository, such as a database or other type of data source. With multiple access types, a particular one may be specified or a faster method may be used within access type 602. Further, access type 602, may be specified through introspection code 604. In this manner, the access type may be identified through introspection code 604 or set through configuration information 614. Different settings may be stored in configuration information 614. For example, an access type may be specified by the user.

Alternatively, configuration information 614 may be set to select the fastest way to access the source. Also, configuration information 614 may be set to always ignore or skip introspection depending on the particular implementation.

Turning now to FIG. 7, a diagram depicting a message flow used in processing a request from a client is depicted in accordance with an illustrative embodiment. In this example, client 700 is an example of a client, such as client 308 in FIG. 3. Request manager 702 is an example of a request manager 314 and interface object 704 is an example of interface object 318, both in FIG. 3. Method 706 and database 708 are examples of methods in a database, such as methods 326 and database 328 in FIG. 3.

In this example, the message flow begins with client 700 sending a request for data to request manager 702 (message M1). In response to receiving this request, request manager 702 sends the request to interface object 704 for processing (message M2). In this example, object interface 704 determines whether the request may be satisfied by querying a single repository.

If the request can be satisfied by querying a single repository, interface object 704 identifies a method, such as method 706 in that repository and sends a request to method 706 (message M3).

In response to receiving the request method 706 processes the request to query database 708 as (message M4). In response to the query, database 708 returns data to method 706 (message M8). This data is also referred to as a result.

Thereafter, method 706 returns the data to interface object 704 (message M7). Interface object 704 then returns the data to request manager 702 (message M6). Thereafter, request manager 702 returns the data to client 700 (message M5).

Turning now to FIG. 8, a diagram illustrating message flow used in retrieving information from repositories is depicted in accordance with an illustrative embodiment. In this example, the components involved include, client 800, request manager 802, interface object 804, connector 806, method 808, database 810, and database 812. Client 800 is an example of a client, such as client 306 in FIG. 3. Request manager 802, interface object 804, and connector 806 may be, for example, request manager 314, interface object 318 and interface object 322 in FIG. 3, respectively. Method 808 and database 810 may be found in configuration management database 302 in FIG. 3. Database 812, may be, for example, federated database 304 in FIG. 3.

In this example, the message flow begins with client 800 sending a request that is received by request manager 802 (message S1). In response, request manager 802 sends the request to interface object 804 for processing (message S2). Interface object 804 determines whether the request requires querying more than one database or repository. This determination of whether the request requires querying one or more database or repository may be performed using introspection. As described above, introspection may be used to identify similar object representing items in these examples.

If more than one repository is needed to return the necessary data or results, interface object 804 then sends the request to connector 806 (message S3). Connector 806 requests a portion of the data by sending a request to database 812 (message S4). The other portion of the data needed for the request is sent by sending a request to method 808 (message S5).

In response to these requests, method 808 processes the requests and queries database 810 (message S6). Database 810 returns data to method 808 (message S7). With this data being then returned to method 808 to connector 806 (message S8). Database 812 returns data to connector 806 (message S9). The information is aggregated by connector 806 and returned to interface object 804 (message S10).

Interface object 804 in turn, sends the data to request manager 802 (message S11). The data is then finally returned to client 800 (message S12). In the depicted examples, the data is for a configuration item. In these examples, a configuration item is an abstraction of an information technology resource. This term is a standard term as defined by the information technology infrastructure libray (ITIL®).

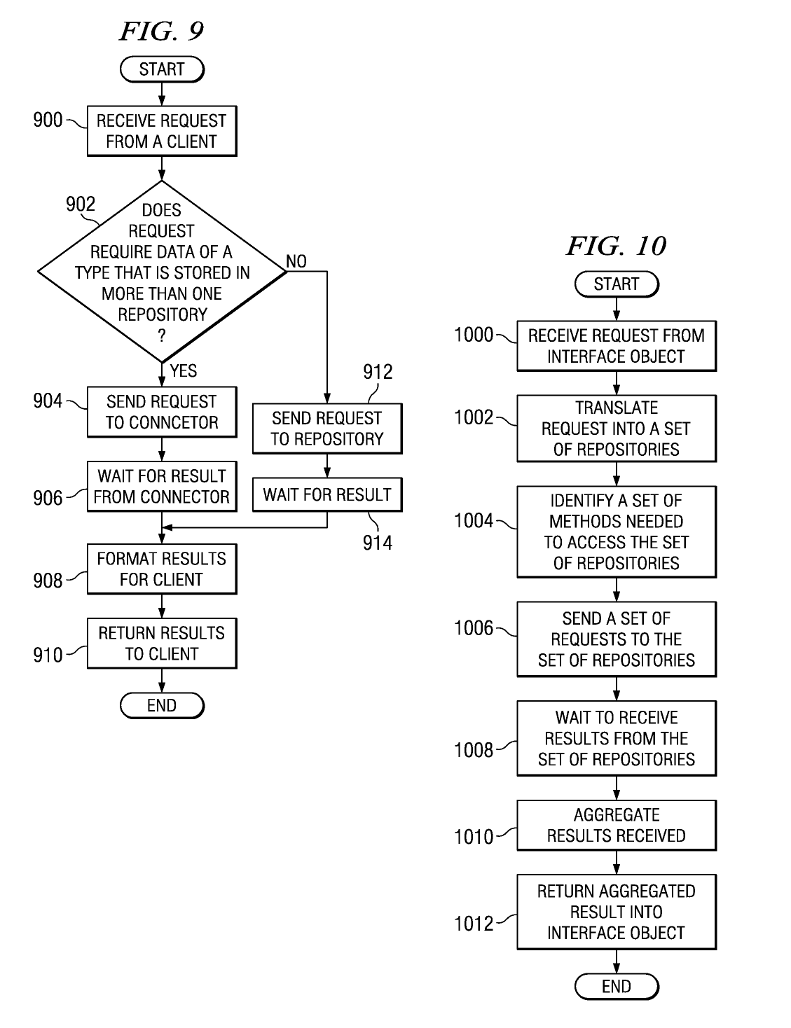

FIG. 9 is a flowchart of a process for an interface object in accordance with an illustrative embodiment. The process illustrated in FIG. 9 may be implemented in a software component, such as interface object 400 in FIG. 4.

The process begins by receiving a request from a client (step 900). A determination is made as to whether a request requires data of a type that is stored in more than one repository (step 902). If the request requires data from more than one repository in step 902, a request is sent to a connector (step 904). The process waits for results form the connector (step 906) and formats the results for the client (step 908). Finally, the process returns the results to the client (step 910).

Turning back to the decision made at step 902, if the process determines that the request requires data from a single repository, the process sends a request to that data repository (step 912) and waits for the results (step 914). Thereafter, the process proceeds to step 908 to format results for the client and continues as described above.

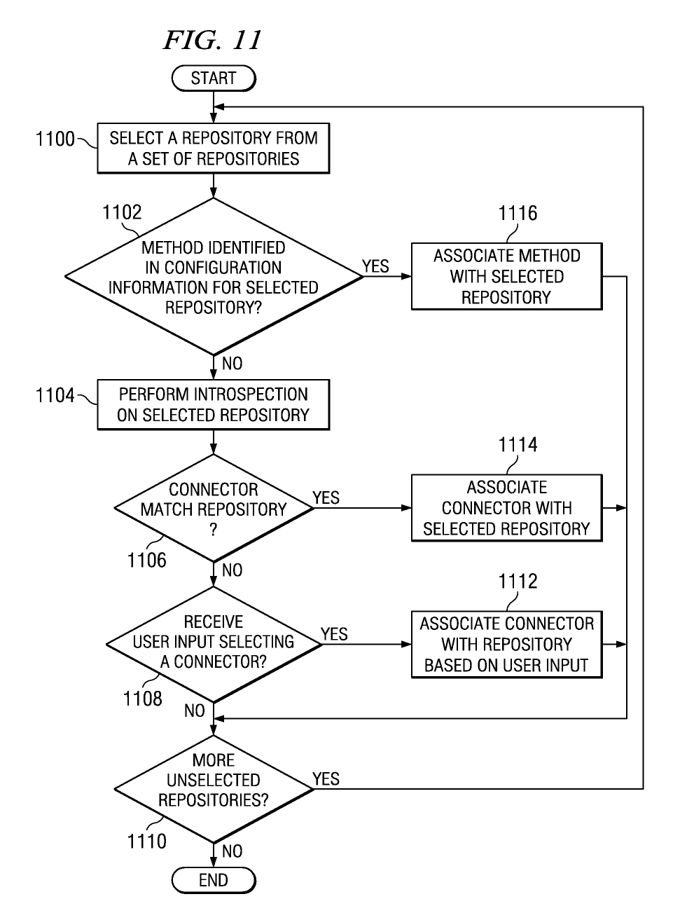

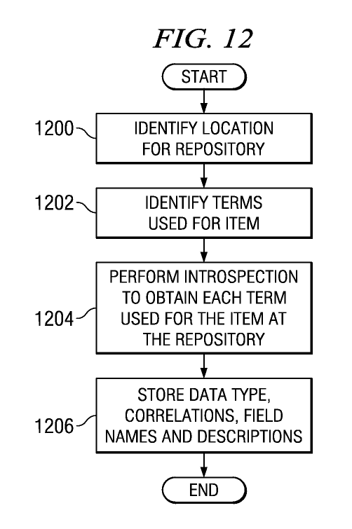

FIG. 10 is a flowchart of a process for a connector object in accordance with an illustrative embodiment. The process illustrated in FIG. 10 may be implemented in a software component, such as connector 500 in FIG. 5.

The process begins by receiving a request from an interface object (step 1000). Next, the request is translated into a set of repositories (step 1002) and a set of methods needed to access the set of repositories is identified (step 1004). The set of requests is sent to the set of repositories (step 1006) and the process waits to receive the results from the set of repositories (step 1008). These results are aggregate results. Thereafter, the aggregate results are received (step 1010). Finally the aggregated results are returned to an interface object (step 1012), with the process terminating thereafter.

Turning next to FIG. 11, a flowchart of a process for identifying an access process for use in accessing information in different repositories is depicted in accordance with an illustrative embodiment. The process illustrated in FIG. 11 may be implemented in a component, such as interface object 318 in FIG. 3.

The process begins by selecting a repository from a set of repositories (step 1100). The process determines if a method is identified in the configuration information for the selected repository (step 1102). The method is a method in the repository that may be used to access the information about the item. If the process determines a method is not identified in step 1102, the process performs introspection on the selected repository (step 1104).

The process then determines if the connector matches the repository (step 1106). In this step, the information from introspection is used to determine if a connector is present that matches the manner in which information is accessed in the repository. If a connector is not present, the process further determines if user input has been received for selecting a connector (step 1108). If user input has not been received in step 1108, the process determines if more unselected repositories are present (step 1110). If more unselected repositories are present, the process returns to step 1100. If no more unselected repositories are present, the process terminates.

Returning to the determination made in step 1108, if the process determines user input has been received, the process associates the connector with a repository based on user input (step 1112) and returns to step 1110 as described above.

Turning back to determination made in step 1106, if the process determines the connector matches the repository, the process associates the connector with the selected repository (step 1114) and returns to step 1110 as described above. Turning further back to the determination made in step 1102, if the process identifies a method in the configuration information for the selected repository, the process associates the method with the selected repository (step 1116) and returns to step 1110. Any associated methods or connectors are used to access the information about the item that is needed to satisfy the requests.

Turning next to FIG. 12, a flowchart of a process for creating a connector is depicted in accordance with an illustrative embodiment. The process illustrated in FIG. 12 may be implemented in a component, such as interface object 400 in FIG. 4.

The process begins by identifying the location for a repository (step 1200). Next, terms used for an item are identified (step 1202). Introspection is performed to obtain each term used for the item at the repository (step 1204). Finally, the data types, correlations, field names, and descriptions are stored (step 1206) with the process terminating thereafter.

Thus, the different illustrative embodiments provide a computer implemented method, apparatus, and computer usable program code for accessing data. The different embodiments use connectors to access data from different repositories. These connectors are reusable connectors that may be used for many different requests. For example, a connector created at one location may be exported or sent for use in another repository or location to access data within a set of repositories. The introspection is used to identify the information or data needed to access the different repositories to obtain information about the item of interest. This information may include, for example, the location of the database, the access method used to access the database, the term or name used to identify the item in that database, and other information needed to create the connector.

In this manner, connectors may be reused rapidly and efficiently to make new connectors, minimizing the need for manual entry of information to access different repositories.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for accessing information in repositories, the computer implemented method comprising:
responsive to receiving a request from a requester for information about an item, determining whether a connector from a plurality of connectors may be used to retrieve the information for the item from the repositories for the request, wherein the plurality of connectors are reusable to access the repositories to obtain information from the repositories that satisfy the request in response to receiving different requests and wherein each connector in the plurality of connectors includes a process and data needed to access a repository to obtain the information from the repository;
responsive to a determination that the connector may be used to retrieve the information about the item, retrieving the information using the connector to form results; and
returning the results to the requester.

2. The computer implemented method of claim 1 further comprising:
responsive to a determination that the connector is unable to retrieve the information for the item, creating a new connector to access the information for the item using one connector in the plurality of connectors as a template; and
retrieving the information from the information for the item using the new connector, wherein the new connector is reusable to access the information for the item in response to subsequent requests.

3. The computer implemented method of claim 2, wherein the creating step comprises:
performing introspection on the repositories to obtain data from the repositories needed to create the new connector from the one connector in the plurality of connectors.

4. The computer implemented method of claim 1, wherein the request is a request to synchronize information for the item in the repositories.

5. The computer implemented method of claim 4, wherein the requester uses the results to synchronize the information for the item.

6. The computer implemented method of claim 1, wherein the item is a configuration item.

7. The computer implemented method of claim 1, wherein the determining, retrieving, and returning steps are performed by an interface object, wherein the interface object comprises a client method and an access process in which the client method receives the request and the access process performs operations needed to obtain the information for the item, wherein the access process uses the plurality of connectors to access the information for the item.

8. The computer implemented method of claim 1, wherein the repositories include a set of configuration management databases.

9. The computer implemented method of claim 1, wherein the computer implemented method is implemented in one location and wherein the connector is reusable in another location to access the repositories.

10. The computer implemented method of claim 1, wherein plurality of connectors may be used as a template to create new connectors.

11. The computer implemented method of claim 1, wherein the determining step comprises:
performing introspection on at least one repository in the repositories; and
using results from the introspection to determine whether the connector may be used to retrieve the information for the item.

12. A computer program product comprising:
a computer usable medium having computer usable program code for accessing information in repositories, the computer program medium comprising:
computer usable program code, responsive to receiving a request from a requester for information about an item, for determining whether a connector from a plurality of connectors may be used to retrieve the information for the item from the repositories for the request, wherein the plurality of connectors are reusable to access the repositories to obtain information from the repositories that satisfy the request in response to receiving different requests and wherein each connector in the plurality of connectors includes a process and data needed to access a repository to obtain the information from the repository;
computer usable program code, responsive to a determination that the connector may be used to retrieve the information about the item, for retrieving the information using the connector to form results; and
computer usable program code for returning the results to the requester.

13. The computer program product of claim 12 further comprising:
computer usable program code, responsive to a determination that the connector is unable to retrieve the information for the item, for creating a new connector to access the information for the item using one connector in the plurality of connectors as a template; and
computer usable program code for retrieving the information from the information for the item using the new connector, wherein the new connector is reusable to access the information for the item in response to subsequent requests.

14. The computer program product of claim 13, wherein the computer usable program code, responsive to a determination that the connector is unable to retrieve the information for the item, creating a new connector to access the information for the item using one connector in the plurality of connectors as a template comprises:
computer usable program code for performing introspection on the repositories to obtain data from the repositories needed to create the new connector from the one connector in the plurality of connectors.

15. The computer program product of claim 12, wherein the request is a request to synchronize information for the item in the repositories.

16. The computer program product of claim 15, wherein the requester uses the results to synchronize the information for the item.

17. The computer program product of claim 12, wherein the item is a configuration item.

18. The computer program product of claim 12, wherein the repositories include a set of configuration management databases.

19. A data processing system comprising:
a bus;
a communications unit connected to the bus;
a storage device connected to the bus, wherein the storage device includes computer usable program code; and
a processor unit connected to the bus, wherein the processor unit executes the computer usable program code, responsive to receiving a request from a requester for information about an item, for determining whether a connector from a plurality of connectors may be used to retrieve the information for the item from the repositories for the request, wherein the plurality of connectors are reusable to access the repositories to obtain information from the repositories that satisfy the request in response to receiving different requests and wherein each connector in the plurality of connectors includes a process and data needed to access a repository to obtain the information from the repository; responsive to a determination that the connector may be used to retrieve the information about the item, for retrieving the information using the connector to form results; and returning the results to the requester.

20. The data processing system of claim 19 wherein the processor unit further executes the computer usable program code to create a new connector to access the information for the item using one connector in the plurality of connectors as a template, in response to a determination that the connector is unable to retrieve the information for the item; and retrieve the information from the information for the item using the new connector, wherein the new connector is reusable to access the information for the item in response to subsequent requests.
